(19) United States
(12) Patent Application Publication
(10) Pub. No.: US 2023/0100466 A1
(43) Pub. Date: Mar. 30, 2023

(54) METHOD OF FORMING TERMINAL END OF AN ARCHFORM

(71) Applicant: Swift Health Systems Inc., Irvine, CA (US)

(72) Inventors: Allen Huynh, Huntington Beach, CA (US); Ishan Shinde, Santa Ana, CA (US); Aiden Hoang, Anaheim, CA (US)

(21) Appl. No.: 17/934,375

(22) Filed: Sep. 22, 2022

Related U.S. Application Data
(60) Provisional application No. 63/247,986, filed on Sep. 24, 2021.

(51) Int. Cl. A61C 7/20; B23K 9/007

(52) U.S. Cl. CPC A61C 7/20; B23K 9/007; A61C 2201/007

(57) ABSTRACT

Archforms with terminal ends that anchor to orthodontic brackets disposed on teeth of the patient and methods of forming the same are disclosed herein. The archforms can include enlarged end portions, such as a ball, that can anchor onto brackets bonded to surfaces of the teeth of the patient.

### CROSS REFERENCE TO RELATED APPLICATIONS

This application claims priority to U.S. Provisional Patent Application No. 63/247,986, filed Sep. 24, 2021, which is incorporated herein by reference in its entirety. Any and all applications, if any, for which a foreign or domestic priority claim is identified in the Application Data Sheet of the present application is hereby incorporated by reference under 37 CFR 1.57.

### BACKGROUND

### Field

The present disclosure relates in some aspects to methods of forming terminal ends of an archform.

### SUMMARY

The distal ends of an archform can be difficult to anchor to brackets on a patient's teeth. In some instances, hooks can be formed by an operator on the distal ends of the archform to anchor to the brackets. However, the formation of the hooks can be operator technique dependent (e.g., hooks for at time of installation in patient's mouth), creating inconsistencies and a lack of precise control over dimensions. The formation of the hooks can also lead to breakages and/or be time consuming. Additionally, the hooks can have sharp edges that can be uncomfortable in the patient's mouth.

Accordingly, archforms with terminal ends with a ball or knob formed thereon and methods for forming said terminal ends are disclosed herein. The methods can include forming a distal end of an archform into a ball or knob with a welding device. The described archforms with balled or knobbed terminal ends can reduce or eliminate operator technique dependence, allow for precise control of dimensions of the terminal ends, reduce or eliminate breaking risk of terminal ends during fabrication, reduce fabrication time, and/or decrease or eliminate reworking of terminal ends.

In some variants, an archform that can move teeth of a patient is disclosed herein. The archform can include a first end that can have a first enlarged end portion that can anchor the first end of the archform to a bracket disposed on a tooth of the patient.

In some variants, the first end can be a distal end of the archform.

In some variants, the first enlarged end portion can be a ball. The first enlarged end portion can have a ball shape. The first enlarged end portion can have a spherical shape. The first enlarged end portion can have a rounded shape.

In some variants, the first enlarged end portion can contact an exterior surface of the bracket to anchor the end of the archform.

In some variants, the first enlarged end portion can contact a curved groove disposed on an exterior surface of the bracket to anchor the end of the archform.

In some variants, the archform can include a custom nonplanar shape.

In some variants, the archform can include a shape memory material.

In some variants, the archform can include a plurality of bracket connectors and a plurality of interproximal segments. The bracket connectors can couple to brackets disposed on the teeth of the patient to prevent relative sliding between the bracket connectors and the brackets. The plurality of interproximal segments can be disposed between adjacent bracket connectors.

In some variants, the bracket connectors can include loops.

In some variants, the interproximal segments can include loops.

In some variants, the archform can include a second end opposite the first end. The second end can include a second enlarged portion. The second end can be a distal end of the archform. The first end can be a right or left distal end of the archform and the second end can be the other of the right or left distal end of the archform.

In some variants, the second enlarged portion can be a ball. The second enlarged end portion can have a ball shape. The second enlarged end portion can have a spherical shape. The second enlarged end portion can have a rounded shape.

In some variants, the bracket can be disposed on a lingual surface of the teeth of the patient.

In some variants, a method of forming an enlarged end portion on an end of an archform is disclosed herein. The method can include advancing an electrode of a welding device to contact a first end of an archform, forming a first enlarged end portion thereon. The method can include advancing the electrode of the welding device to contact a second end, opposite the first end, of the archform, forming a second enlarged end portion thereon.

In some variants, the method can include gripping the archform with a tool.

In some variants, the welding device can be a micro TIG welder.

In some variants, the electrode can be a one millimeter electrode.

In some variants, the first enlarged end portion can include a cross-sectional size that can be larger than a cross-sectional size of the archform.

In some variants, the second enlarged end portion can include a cross-sectional size that can be larger than a cross-sectional size of the archform.

In some variants, the first enlarged end portion can include a ball shape.

In some variants, the second enlarged end portion can include a ball shape

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure.

FIG. 1 illustrates an archform.

FIG. 2A illustrates another configuration of the archform.

FIG. 2B illustrates a connector of the archform coupled to a bracket and a hooked terminal end of the archform.

FIG. 3A illustrates an archform with a terminal end having an enlarged end portion (e.g., ball) and a connector coupled to a bracket.

FIG. 3B illustrates the archform with the terminal end having the enlarged end portion and the connector coupled to the bracket.

FIG. 4A illustrates a first tool poised to grip the archform.

FIG. 4B illustrates an electrode of a welding device positioned proximate a terminal end of the archform.

FIG. 4C illustrates the enlarged end portion formed on the end of the archform.

### DETAILED DESCRIPTION

Malocclusion of the teeth may be treated using orthodontic brackets and archforms to move the patient's teeth using non-sliding mechanics. For example, scans of a patient's teeth can be taken and a digital model of the patient's teeth can be created, at least in part, from the scans. The teeth of the digital model can be moved from positions of malocclusion (e.g., first positions) to second positions, which may be a final expected alignment of the teeth. Digital brackets can be placed, respectively, on the lingual or buccal surfaces of the teeth in the digital model. In some variants, the digital brackets can be placed before moving the teeth of the digital model from the positions of malocclusion (e.g., first positions) to the second positions.

A physical fixture can be created (e.g., 3D printed, machined, and/or otherwise formed) based on the digital model with the teeth in the second positions and the digital brackets placed. The physical fixture can include retention features (e.g., hooks, slots, locks, holders, etc.) that can retain portions of an archform such as bracket connectors. The retention features can be positioned based on the corresponding positioning of the digital brackets in the digital model with the teeth in the second positions, such that the relative positioning of the retention features to each other is the same as or similar to the relative positioning of the digital brackets to each other in the digital model. In some variants, the physical fixture can be a physical model of the patient's teeth corresponding to the digital model of the patient's teeth in the second positions and the retention features positioned on the teeth of the physical model can be based on the corresponding positioning of the digital brackets in the digital model.

An archform, which may also be referred to as an archwire, can be made of a shape memory material, such as nickel-titanium alloy (e.g., Nitinol). The archform can be cut (e.g., laser, waterjet, etc.) from a sheet of material (e.g., shape memory material). The archform can be cut from a wire of material (e.g., shape memory material). The archform can include bracket connectors that can couple to brackets and interproximal segments, such as interproximal loops, that can be configured to move one or more teeth of the patient. When cut from the sheet of material, the archform can have a substantially flat two-dimensional shape. When cut from the sheet of material, the bracket connectors and interproximal segments can be formed when the archform is cut from the sheet of material. When cut from a wire of material, the bracket connectors and interproximal loops can be formed by bending the wire. The archform can be deflected and coupled to the physical fixture to assume a custom nonplanar shape. Specifically, the bracket connectors of the archform can be coupled to the retention features of the physical fixture. While retained in the custom nonplanar shape, the archform can be set, which can be accomplished via exposure to heat. Setting the archform can set a new default or memorized position for the archform such that the archform is biased toward the memorized custom nonplanar shape when deflected therefrom. Accordingly, if the archform is deflected from the memorized custom nonplanar shape, the archform can exert forces to return the archform back toward the memorized custom nonplanar shape.

An indirect bonding (IDB) tray can be formed based on the digital model. The teeth of the digital model, with the digital brackets disposed thereon, can be returned back to the positions of malocclusion that can reflect the current positions of the patient's teeth. In some variants, the IDB tray can be formed based on the digital model with digital brackets placed on the maloccluded teeth of the digital model prior to movement of the teeth to the second positions. An IDB tray can be 3D printed and/or over molded based on the digital model. The IDB tray can be sized and shaped to fit over the teeth of the patient. The IDB tray can include wells (e.g., pockets, recesses, etc.) that can house orthodontic brackets therein. The wells can be positioned based on the corresponding positioning of the digital brackets in the digital model.

Orthodontic brackets can be placed in respective wells of the IDB tray with contact surfaces (e.g., bonding surfaces) exposed. An adhesive can be applied to the contact surfaces and the loaded IDB tray can be placed over the teeth of the patient, positioning the orthodontic brackets at locations on the teeth of the patient that correspond to the positioning of the digital brackets on the teeth in the digital model. The orthodontic brackets can bond to the teeth of the patient, which can be facilitated by exposing the adhesive to light (e.g., UV light) and/or heat.

With the orthodontic brackets bonded to the teeth of the patient, the archform can be deflected from the memorized custom nonplanar shape and coupled to the bonded orthodontic brackets. The bracket connectors of the archform can be coupled, e.g., locked, to the bonded orthodontic brackets such that the archform does not slide with respect to the brackets. As described, the deflected archform can exert forces on the teeth of the patient as the archform exerts forces to move toward the undeflected position (e.g., memorized custom nonplanar shape), which can move the teeth of the patient, using non-sliding mechanics, toward seconds positions that correspond to the second positions of the teeth in the digital model (e.g., final alignment of the teeth).

In some variants, a series of archforms can be sequentially installed in the patient's mouth (e.g., coupled to the brackets) and then replaced to move the patient's teeth from positions of malocclusion to second positions. For example, an initial archform set in the custom nonplanar shape may be used for an initial stage of treatment for initially moving the teeth of the patient toward the second positions. An intermediate archform set in the custom nonplanar shape, which may be stiffer than the initial archform, may be used for an intermediate stage of treatment for moving the teeth of the patient closer toward the second positions. A final archform set in the custom nonplanar shape, which may be stiffer than the intermediate archform, may be used for a final stage of treatment for moving the teeth of the patient closer toward or to the second positions.

Although references are made herein to archforms used to move teeth using non-sliding mechanics, the balled or knobbed terminal ends and methods of making the same can be applied to archforms used for moving teeth using sliding mechanics.

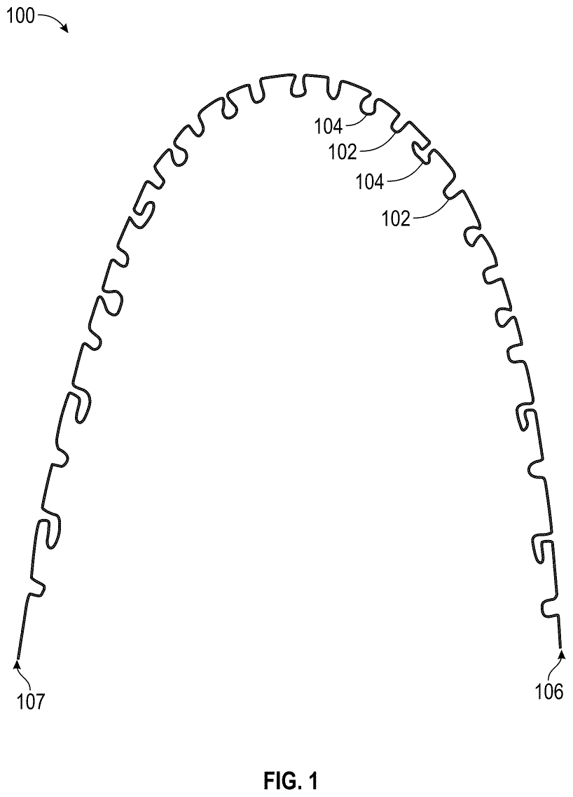

FIG. 1 illustrates an archform 100 (archwire) that can be deflected and coupled to brackets in a patient's teeth to move teeth from positions of malocclusion to second positions. The archform 100 can follow a portion or an entirety of a patient's dental arch. As described herein, the archform 100 can be custom shaped according to a patient's treatment plan, which may be planned using a digital model. The archform 100 can have a variety of cross-sections which can include circular, oval, polygonal (e.g., square, rectangular, etc.), irregular, and/or others. In some variants, the archform can be flat. The archform 100 can be made of a variety of materials, which can at least include shape memory materials (e.g., nickel titanium).

The archform 100 can include one or more connectors 102 (connecting loops, locking loops, male loops, bracket connectors). The connectors 102 can be coupled to corresponding brackets disposed on the lingual or buccal surfaces of a patient's teeth. The connectors 102 can correspond with the teeth of the patient and brackets placed thereon. The connector 102 can couple to a bracket such that the connector 102 does not slide and/or otherwise move with respect to the bracket. In some variants, the connectors 102 can include loops that extend away from a longitudinal axis of the archform 100 in a gingival direction to define a gap, open in the occlusal direction. In some variants, the connectors 102 can include loops that extend away from a longitudinal axis of the archform 100 in an occlusal direction to define a gap, open in the gingival direction.

The archform 100 can include one or more interproximal segments 104 (interproximal loops). The interproximal segment 104 can be disposed between adjacent connectors 102. In some variants, the interproximal segments 104 can include loops that extend away from a longitudinal axis of the archform 100 in a gingival direction to define a gap, open in the occlusal direction, which can facilitate flossing and/or be aesthetically pleasing. In some variants, the interproximal segment 104 can be loops that extend away from a longitudinal axis of the archform 100 in an occlusal direction to define a gap, open in the gingival direction. When the archform 100 is installed in a patient's mouth, the interproximal segment 104 can apply forces to the brackets bonded to the patient's teeth to move the patient's teeth. For example, the loops of the interproximal segments 104 can open and/or close to return toward un undeflected configuration of the archform 100 to move the patient's teeth closer together or farther apart.

The archform 100 can include a first distal end 106 and a second distal end 107. The first distal end 106 can be disposed proximate a first distal portion of the patient's dental arch. The second distal end 107 can be disposed proximate a second distal portion of the patient's dental arch. In some variants, the first distal end 106 and/or second distal end 107 can be disposed at more anterior positions than the distal portions of the patient's dental arch.

As described herein, the archform 100 can be deflected from a custom memorized shape to couple the connectors 102 to brackets on a patient's teeth. The archform 100 can apply forces to the brackets as the archform 100 moves toward the undeflected custom memorized shape, which applies forces to the patient's teeth to move the patient's teeth toward second positions.

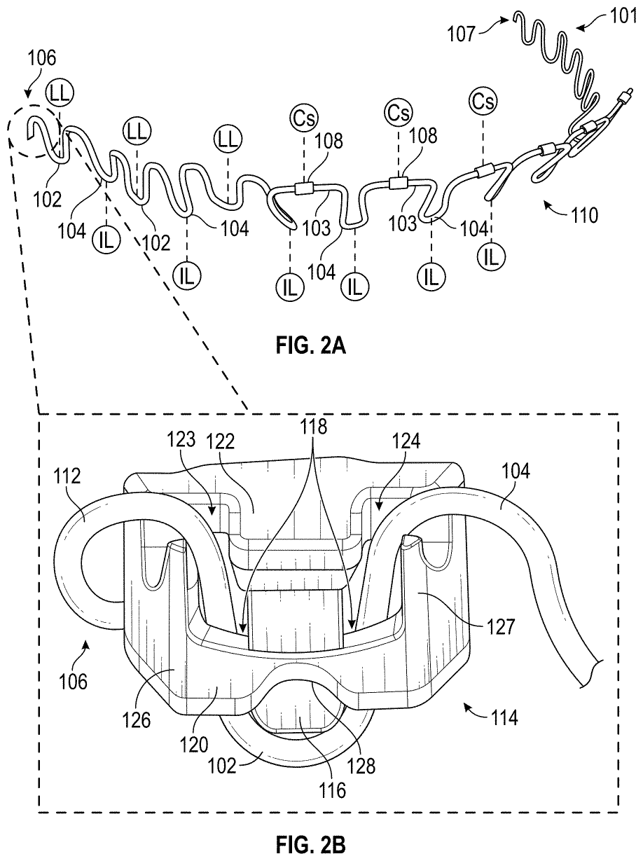

FIG. 2A shows another configuration of an archform 101, which may include any of the features described in reference to the archform 100. The archform 101 can include a plurality of connectors 102 with interproximal segments 104 disposed between adjacent connectors 102. As shown, the connectors 102 and interproximal segments 104 can extend in a gingival direction. In some variants, an enlarged portion 108 may be disposed on a connecting portion 103 of the archform 101 in place of a connector 102, which may be suitable for connecting to brackets disposed on the patient's teeth having limited surface area. For example, the lower anterior teeth may have limited surface area for bracket placement. Accordingly, a smaller bracket may be disposed on the lower anterior teeth that may be incompatible or undesirable for use with a connector 102. The connecting portion 103 can be disposed between adjacent interproximal segments 104. The connecting portion 103 can be devoid of loops. The connecting portion 103 can be a straight portion. The connecting portion 103 can follow the longitudinal axis of the archform 101. An enlarged portion 108 can be disposed (e.g., formed, coupled) on the connecting portion 103. The enlarged portion 108 can have a cross-sectional size (e.g., diameter) that is larger than the cross-sectional size (e.g., diameter) of the connecting portion 103 and/or other portions of the archform 101. In some variants, the enlarged portion 108 can be crimped, adhered, welded, and/or otherwise coupled to the connecting portion 103. In some variants, the enlarged portion 108 can be a tubular attachment or member. The archform 101 can include first distal end 106 and second distal end 107.

FIG. 2B illustrates the connector 102 coupled to a bracket 114 and a first distal end 106 of the archform 101. The bracket 114 can include a slot 118 (receiving region or space) in which the connector 102 can be disposed to prevent relative sliding between the connector 102 and the bracket 114. The bracket 114 can include a mesial slot 124 and distal slot 123 through which the archform 101 can enter and exit to position the connector 102 within the slot 118 of the bracket 114. The loop of the connector 102 can curve around a protrusion 116 extending away from a stop 122 of the bracket 114. The loop of the connector 102 can be disposed between a mesial wall 127 and the protrusion 116, around an end of the protrusion 116 (e.g., curved end of the protrusion 116), and between the distal wall 126 and the protrusion 116. In some variants, the protrusion 116 can be a springboard that can deflect as the loop of the connector 102 is slid over the protrusion 116 and, once slid over such that the loop of the connector 102 extends around an end of the protrusion 116, return to an undeflected position that locks the connector 102 within the bracket 114. The bracket 114 can include a bridge 120 that can extend between the mesial wall 127 and distal wall 126. The bridge 120 can extend over at least a portion of the slot 118 and can pin the connector 102 between the bridge 120 and a surface (e.g., lingual or buccal) of the bracket 114. The bridge 120 can include a notch 128 through which a tool can be inserted to contact and deflect the protrusion 116 to remove (e.g., decouple) the connector 102 from within the slot 118 of the bracket 114.

As shown, the first distal end 106 of the archform 101 can extend past the distal wall 126 of the bracket 114. The first distal end 106 can include a hook 112 that can curve around the distal wall 126 of the bracket 114. The hook 112 can be formed by an operator. The hook 112 can anchor the first distal end 106 to the bracket 114 (e.g., distal wall 126), which can help to prevent sliding of the archform 101 relative to the bracket 114 and/or the connector 102 relative to the bracket 114. The hook 112 can curve in a gingival and/or occlusal direction. The hook 112 can curve such that an end thereof contacts a wall (e.g., distal wall 126 or mesial wall 127) of the bracket 114. The hook 112 can include an end that is disposed away from tissue inside the mouth to promote user comfort.

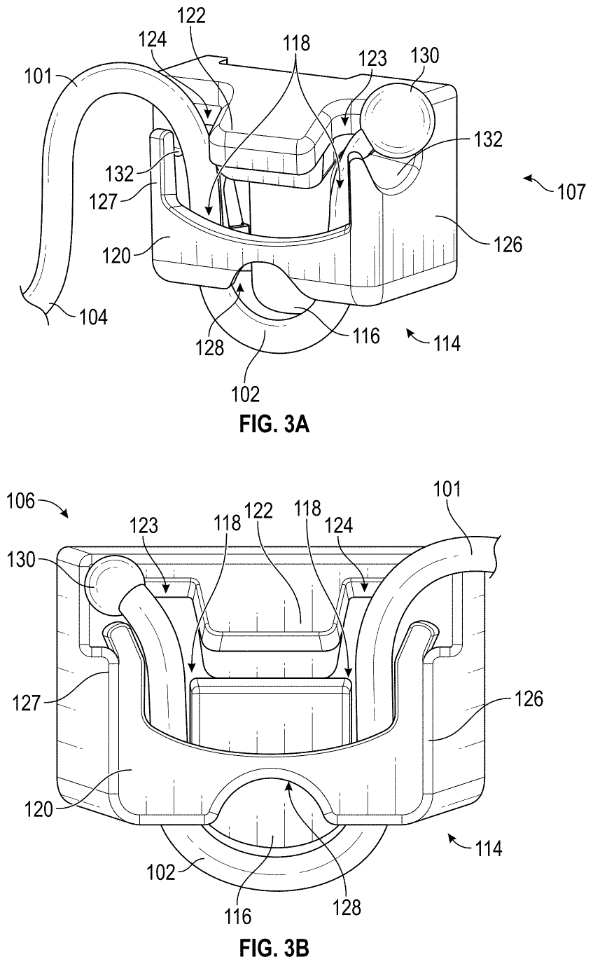

FIG. 3A illustrates the connector 102 of the archform 101 coupled to the bracket 114. The loop of the connector 102 can be disposed in the slot 118 of the bracket 114 as described in reference to FIG. 2B. The second distal end 107 of the archform 101 can include an enlarged end portion 130 (ball, knob, sphere, bead, bulb) formed thereon. In some variants, the enlarged end portion ball 130 can have a cross-sectional size (e.g., diameter) that is larger than a cross-sectional size (e.g., diameter) of the archform 101. The enlarged end portion 130 can anchor the second distal end 107 or first distal end 106 to the bracket 114. In some variants, the enlarged end portion 130 can anchor an end (e.g., first distal end 106 or second distal end 107) of the archform 101 to a bracket 114 corresponding to the connector 102 proximate the end of the archform 101. The bracket 114 can include a groove 132 (contour, recess, receiving region) that can be disposed in the distal wall 126 and/or mesial wall 127, which can include an occlusal or gingival most portion of the distal wall 126 and/or mesial wall 127. The groove 132 can receive the enlarged end portion 130 of the archform 100 therein to anchor the end of the archform 101 (e.g., first distal end 106, second distal end 107) to the bracket 114 (e.g., distal wall 126, mesial wall 127). In some variants, the enlarged end portion 130 can be a ball and the groove 132 can be a curved surface. The enlarged end portion 130 being a ball or the like can improve user comfort by reducing sharp edges and/or be less likely to break compared to a hook. As illustrated, the enlarged end portion 130 can be disposed in a groove 132 of the distal wall 126 of the bracket 114.

As illustrated in FIG. 3B, the enlarged end portion 130 can be formed on the first distal end 106 of the archform 101. The connector 102 can disposed in the slot 118 of the bracket 114. The enlarged end portion 130 (e.g., ball) can be disposed in the groove 132 of the distal wall 126 of the bracket 114, which can anchor the enlarged end portion 130 to the distal wall 126.

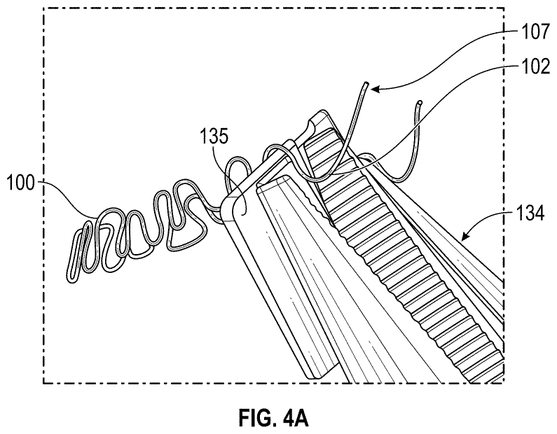

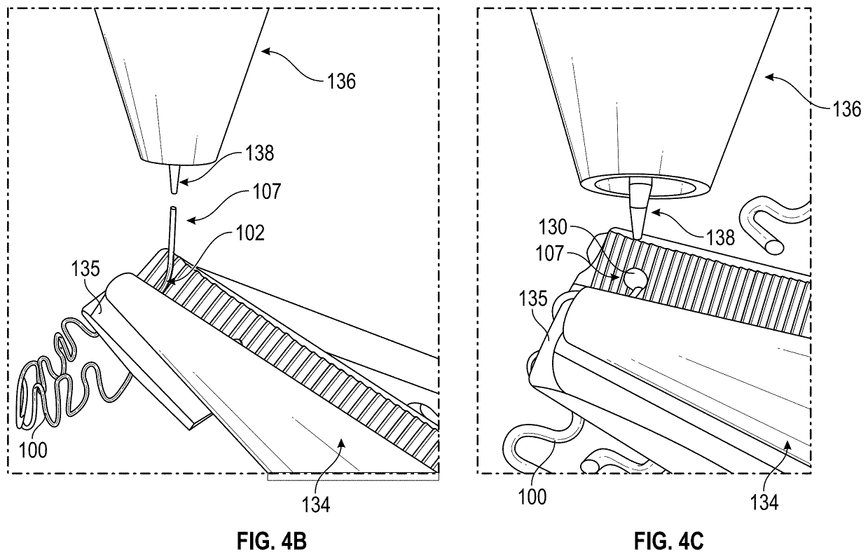

FIGS. 4A-4C illustrate steps of a method of forming the enlarged end portion 130 on an end (e.g., second distal end 107) of the archform 100. As shown in FIG. 4A, the archform 100 or archform 101 can be gripped by a first tool 134 (e.g., welding fixture). For example, the first tool 134 can grip a connector 102 (e.g., last connector 102) proximate an end (e.g., first distal end 106, second distal end 107) of the archform 100. A fixture (e.g., flange, tab, support, plate, insert, prong, tool) 135 can be inserted into the loop of the interproximal segment 104 adjacent the last connector 102 or another loop of the archform 100 to help support the archform 100. As shown in FIG. 4B, the end of the archform 100 can be oriented to point upward or generally upward. A welding device 136 (e.g., TIG welder, micro TIG welder), which can operate with argon gas, can be positioned such that an electrode 138 (e.g., 1.0 millimeter electrode, such as an electrode with a diameter that is 1.0 millimeters) thereof is positioned proximate the end of the archform 100. The electrode 138 can be advanced to contact the end of the archform 100, forming the enlarged end portion 130 (e.g., ball) thereon—as shown in FIG. 4C—one end of the archform 100. A second tool (e.g., welding fixture), or the first tool 134, can grasp a connector 102 (e.g., last connector 102) proximate an opposite end (e.g., first distal end 106, second distal end 107) of the archform 100. The electrode 138 can be advanced to contact the opposite end of the archform 100, as described herein, to form the enlarged end portion 130 (e.g., ball) thereon.

Reference is made herein to orthodontic appliances and brackets that move teeth using non-sliding mechanics. However, this disclosure should not be limited to non-sliding mechanics. The methods, apparatuses, and/or systems disclosed herein can be applicable to configurations using sliding mechanics. The methods, apparatuses, and/or systems disclosed herein can be applicable to at least any orthodontic treatment plan that involves coupling an archform to the teeth of the patient and/or bonding and/or placing orthodontic brackets on the teeth of the patient. For example, orthodontic brackets formed and cured from an adhesive, as described herein, can be bonded to a patient's teeth and an archform can be coupled thereto that is configured to slide relative to the cured orthodontic bracket to move teeth of the patient.

It is intended that the scope of this present invention herein disclosed should not be limited by the particular disclosed embodiments described above. This invention is susceptible to various modifications and alternative forms, and specific examples have been shown in the drawings and are herein described in detail. This invention is not limited to the detailed forms or methods disclosed, but rather covers all equivalents, modifications, and alternatives falling within the scope and spirit of the various embodiments described and the appended claims. Various features of the orthodontic brackets and archforms described herein can be combined to form further embodiments, which are part of this disclosure. The orthodontic brackets described herein can be bonded to a patient's teeth and the archforms described herein can be deflected and coupled thereto as part of a treatment plan. The archforms can move toward a default position and move the patient's teeth from a first position to a second position. The archforms described herein can be installed in sequence to move the patient's teeth. The orthodontic brackets described herein can be bonded to the teeth of the patient in various orientations, which can include orienting the orthodontic bracket in a first gingival-occlusal orientation and reorienting the orthodontic bracket one hundred and eighty degrees to a second gingival-occlusal orientation (e.g., rotating the orthodontic bracket one hundred and eighty degrees).

Methods of using the orthodontic brackets and/or archforms (including device(s), apparatus(es), assembly(ies), structure(s) or the like) are included herein; the methods of use can include using or assembling any one or more of the features disclosed herein to achieve functions and/or features of the system(s) as discussed in this disclosure. Methods of manufacturing the foregoing system(s) are included; the methods of manufacture can include providing, making, connecting, assembling, and/or installing any one or more of the features of the system(s) disclosed herein to achieve functions and/or features of the system(s) as discussed in this disclosure.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “tying a tie onto an orthodontic bracket” includes “instructing the tying of a tie onto an orthodontic bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

1. An archform configured to move teeth of a patient, the archform comprising:
a first end comprising a first enlarged end portion configured to anchor the first end of the archform to a bracket disposed on a tooth of the patient.

2. The archform of claim 1, wherein the first enlarged end portion is a ball.

3. The archform of claim 1, wherein the first enlarged end portion is configured to contact an exterior surface of the bracket to anchor the end of the archform.

4. The archform of claim 1, wherein the first enlarged end portion is configured to contact a curved groove disposed on an exterior surface of the bracket to anchor the end of the archform.

5. The archform of claim 1, wherein the archform comprises a custom nonplanar shape.

6. The archform of claim 1, wherein the archform comprises a shape memory material.

7. The archform of claim 1, wherein the archform comprises a plurality of bracket connectors and a plurality of interproximal segments, the bracket connectors configured to couple to brackets disposed on the teeth of the patient to prevent relative sliding between the bracket connectors and the brackets, and the plurality of interproximal segments disposed between adjacent bracket connectors.

8. The archform of claim 7, wherein the bracket connectors comprise loops.

9. The archform of claim 7, wherein the interproximal segments comprise loops.

10. The archform of claim 1, further comprising a second end opposite the first end, the second end comprising a second enlarged portion.

11. The archform of claim 10, wherein the second enlarged portion is a ball.

12. The archform of claim 1, wherein the bracket is disposed on a lingual surface of the teeth of the patient.

13. A method of forming an enlarged end portion on an end of an archform, the method comprising:
advancing an electrode of a welding device to contact a first end of an archform, forming a first enlarged end portion thereon; and
advancing the electrode of the welding device to contact a second end, opposite the first end, of an archform, forming a second enlarged end portion thereon.

14. The method of claim 13, further comprising gripping the archform with a tool.

15. The method of claim 13, wherein the welding device is a micro TIG welder.

16. The method of claim 13, wherein the electrode is a one millimeter electrode.

17. The method of claim 13, wherein the first enlarged end portion comprises a cross-sectional size that is larger than a cross-sectional size of the archform.

18. The method of claim 13, wherein the second enlarged end portion comprises a cross-sectional size that is larger than a cross-sectional size of the archform.

19. The method of claim 13, wherein the first enlarged end portion comprises a ball shape.

20. The method of claim 13, wherein the second enlarged end portion comprises a ball shape.
